(19) United States
(12) Patent Application Publication
(10) Pub. No.: US 2025/0322438 A1
(43) Pub. Date: Oct. 16, 2025

(54) AGENTIC SYSTEM USING GENERATIVE MODELS TO CREATE ORDERS FOR AN ONLINE CONCIERGE SYSTEM BASED ON USER QUERIES

(71) Applicant: Maplebear Inc., San Francisco, CA (US)

(72) Inventors: Joseph Olivier, San Bruno, CA (US); Brent Luna, Oakland, CA (US); Mridul Singhai, San Francisco, CA (US); Lukasz Czekaj, North Las Vegas, NV (US); Reece Boyd, Brentwood, TN (US); Nathan Marks, Toronto (CA)

(21) Appl. No.: 18/634,754

(22) Filed: Apr. 12, 2024

(51) Int. Cl. G06Q 30/0601

(52) U.S. Cl. CPC G06Q 30/0613

(57) ABSTRACT

An online concierge system receives a query from a user and leverages a set of models to generate an order based on the query. An ingredient identification model is a generative model that receives the query and generates a set of item categories corresponding to items that are combined to satisfy the query. An item identification model trained on catalogs of items offered by retailers receives the set of item categories as an input and generates a list of items available at a retailer corresponding to the set of item categories. The item identification model may generate multiple lists corresponding to different retailers and select a specific list of items based on list scores determined for each list. A candidate order form creation model generates characteristics of an order for obtaining the list of items that leverages prior orders fulfilled for the user.

### BACKGROUND

Online concierge systems receive orders from users for items offered by one or more retailers and allocate an order to a picker for fulfillment. A picker to whom the order was allocated obtains items in the order from a retailer identified by the order. Subsequently, the picker fulfills the order by delivering the obtained items to a user from whom the online concierge system received the order.

When generating an order using conventional online concierge systems, a user identifies different individual items from a retailer for inclusion in the order. For example, the online concierge system receives a search query from a user and displays items offered by a retailer having item attributes that at least partially satisfy the search query. Subsequently, the user selects one or more of the identified items for inclusion in an order. The user may subsequently provide additional search queries to the online concierge system and select subsequently identified items to include multiple items in an order.

As conventional online concierge systems have users individually identify different items for inclusion in an order, users provide multiple inputs to conventional online concierge systems when creating an order. For example, a user provides multiple search queries to an online concierge system to identify various items for an order. Providing multiple search queries and selecting different items for an order causes a user to navigate through multiple interfaces generated by the online concierge system to include different items in an order. Providing multiple inputs and navigating through multiple interfaces increases an amount of time for a user to create an order. Increased interaction and time spent creating an order decreases a likelihood of a user including large numbers of items in orders and decreases a number of subsequent orders an online concierge system receives from the user.

### SUMMARY

In accordance with one or more aspects of the disclosure, a user creates an order for fulfillment by an online concierge system. The order includes various characteristics describing how items are obtained to fulfill the order. Example characteristics of an order include item identifiers of items for a picker to obtain, an identifier of a retailer from whom the items are obtained, a delivery location where the picker delivers the item, a time interval for the picker to deliver the items to the delivery location, and a payment method for the picker providing compensation for the items. However, different or additional characteristics may be included in an order in various embodiments.

Conventionally, a user identifies a retailer to the online concierge system and selects individual items offered by the retailer for inclusion in an order. For example, an application associated with the online concierge system executing on a user client device displays one or more ordering interfaces to the user. The user provides one or more search queries or other information for identifying items to the online concierge system via an ordering interface and selects one or more items identified by the online concierge system via an ordering interface for inclusion in an order. Hence, a user provides multiple inputs and navigates through multiple ordering interfaces when conventionally generating an order for fulfillment through an online concierge system.

To reduce an amount of user interaction by a user to create an order, the online concierge system receives a query from the user via an ordering interface presented by a user client device. In various embodiments, the query comprises unstructured text including a user intent, which may include a result from combining multiple items. For example, the query includes a name or a description of a dish resulting from combining a combination of items as described in a recipe or other set of instructions. Alternatively, the query comprises an image of a result of a combination of items obtained from a retailer. Additional information may also be included in the query, such as timing information of when the user intends to create the result, preferences of the user for one or more item attributes of items for creating the result, or other information related to obtaining items for creating the result specified by the query.

The online concierge system applies an order generation agent to the query to select items to obtain so a combination of the selected items creates the result included in the query and to generate characteristics for an order to obtain the selected items for the user. This allows the user to leverage the order generation agent to select items for combining to create the result and to generate an order for the selected items based on the query rather than individually identifying discrete items for inclusion in an order and manually specifying characteristics for the order. In various embodiments, the order generation agent includes multiple models that exchange information with each other, with information from a model of the order generation agent being used by another model of the order generation agent to generate additional information. In various embodiments, the order generation agent includes an ingredient identification model, an item identification model, and a candidate order form creation model. However, in other embodiments, the order generation agent includes a different number of models. Further, as the order generation agent accesses information associated with a retailer, such as a catalog of items offered by the retailer, in various embodiments the online concierge system limits the order generation agent's access to information associated with retailers who have expressly granted such access to the order generation agent. For example, the online concierge system stores an access permission in association with an identifier of a retailer based on an input received from the retailer and does not permit the order generation agent to access information associated with the retailer unless the access permission has a specific value. This provides different retailers with control over whether the order generation agent is capable of accessing information associated with the retailer and maintained by the online concierge system.

The ingredient identification model receives the query as an input and generates a set of item categories based on the query. Each item category of the set corresponds to one or more items, so a combination of different items corresponding to different item categories of the set allows the user to create the result identified by the query. So, by combining an item from each item category of the set of item categories, the user is able to create the result specified by the query. However, multiple items may correspond to each item category, so the set of item categories identifies a pool of potential items for combination to create the result identified by the query. For example, an item category of “cheese” includes various items with different item attributes (e.g., different types of cheese, different quantities of cheese, etc.).

In various embodiments, the ingredient identification model is a generative model, such as a large language model, initially trained on a large corpus of text or images and subsequently tuned using recipes obtained by the online concierge system to generate a set of item categories in response to receiving a received query. A recipe includes a combination of item categories and instructions for combining items included in the item categories to generate a result. A recipe name, a recipe description, or an image associated with the recipe identifies a result from combining items corresponding to different item categories of the recipe. Tuning the ingredient identification model based on the recipes obtained by the online concierge system allows the ingredient identification model to leverage contextual relationships between item categories from their inclusion in recipes to generate a set of items based on a result from combining items identified in the query. The online concierge system may tune the ingredient identification model by generating a prompt including the query and one or more ingredient examples selected based on the query to which the ingredient identification model is applied. Each ingredient example includes information identifying a recipe and a set of item categories associated with the recipe, so including an ingredient example in the prompt provides the ingredient identification model with an example of the expected output.

The ingredient identification model also extracts metadata from the query in various embodiments. For example, the ingredient identification model extracts timing information from the query including information describing an intended time for order fulfillment or a speed at which the user expects to receive items based on the query. The timing information may be specific words or phrases from the query. Other metadata extracted from the query may include one or more preferences for items by the user, dietary restrictions of the user, or other characteristics of the user affecting items that the user historically obtained. The ingredient identification model may be tuned to extract metadata through application to examples including types of metadata or may be trained to extract metadata5 because of its initial training on a corpus of text or images.

Alternatively or additionally, the order generation agent obtains metadata associated with the query by retrieving characteristics associated with the user stored in a data store of the online concierge system. The ingredient identification model may retrieve the metadata from the data store based on an identifier of the user from whom the query was received. For example, the order generation agent obtains preferences or dietary restrictions of the user from a profile stored in the data store in association with the user. As another example, the order generation agent obtains one or more item attributes of items previously obtained by the user from historical orders fulfilled for the user by the online concierge system and stored in the data store. In some embodiments, the order generation agent retrieves a subset of metadata from the data store using one or more additional processes, while the ingredient identification model extracts additional metadata from the query. Different metadata may be extracted or obtained for different users or in response to the order generation agent receiving different queries in various embodiments.

The order generation agent applies the item identification model to the set of item categories to generate one or more lists of items. For example, the item identification model receives the set of item categories as an input and generates one or more lists of items in response to these set or item categories. In various embodiments, a list of items generated by the item identification model includes multiple items, with each item included in at least one item category of the set of item categories. Further, the list of items includes at least one item included in each item category of the set of item categories. In various embodiments, the list of items is associated with a retailer from which the items included in the list of items are to be obtained. The item identification model may receive metadata, such as preferences of the user, as input along with the set of item categories and generate the list of items to satisfy the metadata received with the set of item categories.

In various embodiments, the item identification model is a generative model, such as a large language model, trained on a large corpus of text and tuned using catalogs of items offered by different retailers and identified relationships between items and item categories. Tuning the item identification model leverages an item catalog of items offered by a retailer and identified relationships between items offered by the retailer and item categories to determine which items offered by the retailer are included in different item categories. However, in other embodiments, the item identification model comprises an alternative type of model trained to select an item corresponding to an item category based on characteristics of the user and item attributes of items offered by a retailer. The output of the item identification model identifies specific items corresponding to different item categories of the set of item categories and a retailer for obtaining the specific items. Hence, the item identification model maps more general item categories of the set of item categories to specific items a picker is capable of obtaining from a retailer.

In some embodiments, the item identification model generates a single list of items selected from candidate lists of items generated for different retailers or generated for a retailer. Each candidate list includes a different combination of items from a retailer based on the set of item categories. Different candidate lists may correspond to different retailers, such as different retailers within a threshold distance of a location associated with the user, so the item identification model evaluates different retailers from which items are capable of being obtained. In various embodiments, the item identification model selects the list of items by determining a list score for each candidate list and selecting one or more lists of items based on the corresponding list scores. Alternatively, the item identification model generates multiple lists of items, with different lists of items each including at least one different item for at least one item category of the set of item categories.

With a list of items generated for the query by the item identification model, the order generation agent generates characteristics of an order form obtaining the list of items by applying the candidate order form creation model to the list of items and a corresponding retailer generated by the item identification model. In various embodiments, the candidate order form generation model receives the list of items, the retailer, and metadata associated with the user as input and generates an order form including characteristics of an order for obtaining the list of items from the retailer. Example characteristics of an order included in the order form include a time interval for fulfilling the order, a payment method used by the user to pay for the order, a location where items of the list of items are to be delivered, or other information describing how a picker obtains the items and delivers the items to the user.

In various embodiments, the candidate order form generation model is a generative model, such as a large language model, tuned using prior orders fulfilled for the user and stored in the data store of the online concierge system. Tuning the candidate order form creation model from prior orders fulfilled for the user allows the candidate order form creation model to account for historical patterns or preferences of the user when creating orders, so the characteristics of the order are tailored to the user. Additionally, the candidate order form creation model may receive metadata extracted from the query by the ingredient identification model or obtained from the data store along with the list of items and use the metadata when generating the characteristics of the order included in the order form.

The order form includes characteristics of the order generated by the candidate order form creation model. For example, the order form identifies the items of the list, a retailer from which the items are to be obtained, a location where the items are to be delivered, a time interval during which the items are to be delivered to the user, and a payment method for the online concierge system to charge the user for the items. However, in other embodiments, the order form includes different or additional characteristics for the order. In some embodiments, the online concierge system generates an order for the user using the characteristics included in the order form in response to the candidate order form generation model generating the order form.

Alternatively, the online concierge system transmits the order form to the user client device of the user for review. In response to receiving an approval of the order form from the user via the user client device, the online concierge system generates the order for the user to obtain the items of the list with the characteristics specified by the order form. The online concierge system may receive a rejection of the order form from the user including one or more modifications to the order form. In response to the received rejection, the candidate order form generation model modifies one or more characteristics of the order and transmits a modified order form to the user client device for review. In response to receiving an approval of the modified order form from the user, the online concierge system generates the order for the user using the characteristics included in the modified order form. This allows the user to iteratively modify one or more characteristics of the order through rejections provided to the order generation agent prior to the online concierge system creating the order for the user.

Hence, the order generation agent receives a query from the user, generates a list of items for the query, identifies a retailer from which the list of items are obtained, and generates other characteristics for the order based on the query. This reduces an amount of interaction by the user with the online concierge system to generate an order. Rather than manually search items offered by a retailer and select individual items for inclusion in an order, providing the query to the order generation agent allows the user to identify a result for a combination of items from which the order generation agent generates items to provide the identified result and characteristics of an order for obtaining the generated items. As the order generation agent generates a list of items and characteristics of an order based on a received query, the order generation agent reduces an amount of interaction with the online concierge system by the user to create an order, increasing a likelihood of subsequent interaction with the online concierge system by the user and simplifying inclusion of a larger number of items in the order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates a flowchart of a method for an order generation agent executing on an online concierge system selecting items for an order and generating the order based on a query received from a user, in accordance with one or more embodiments.

FIG. 4 is an interaction diagram showing an example of data exchange between models comprising an order generation agent executing on an online concierge system, in accordance with one or more embodiments.

FIG. 5 is a process flow diagram of a method for an order generation agent executing on an online concierge system selecting items for an order in response to a received query from a user, in accordance with one or more embodiments.

### DETAILED DESCRIPTION

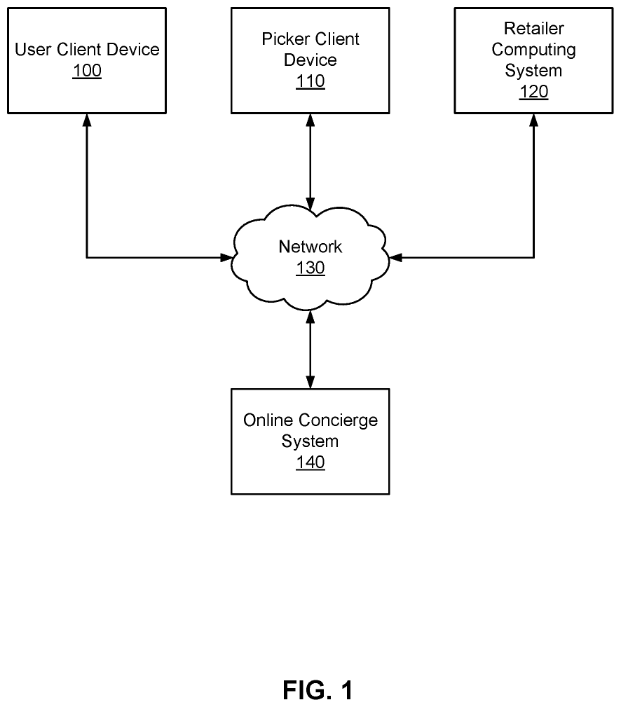

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform its respective functionalities in response to a request from a human, or automatically without human intervention.

As used herein, users, pickers, and retailers may be generically referred to as “users” of the online concierge system 140. Additionally, while one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

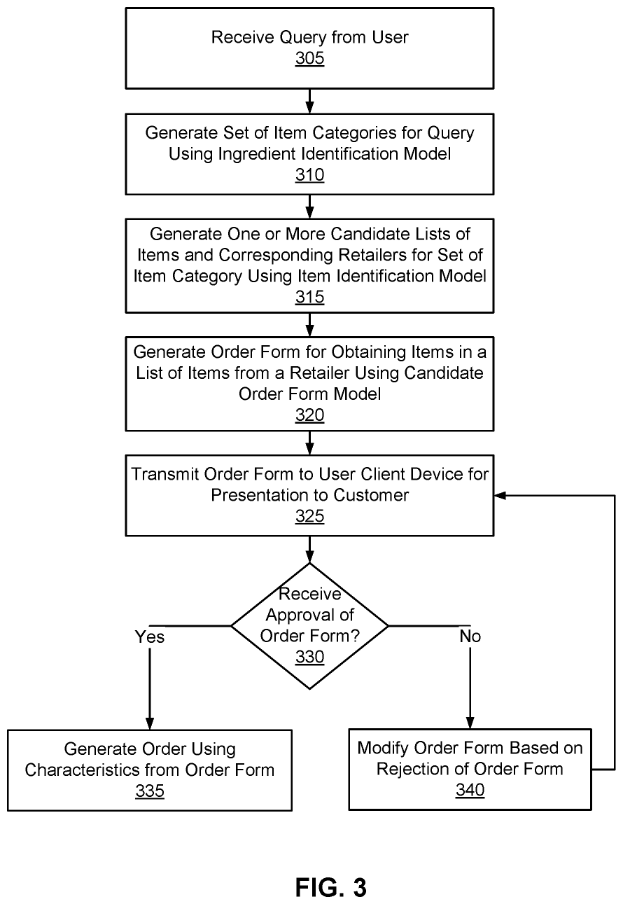

In various embodiments, the ordering interface presented to the user by the user client device 100 includes one or more interface elements for receiving a query. For example, the ordering interface includes a search box configured to receive input from the user. In some embodiments, the query comprises unstructured text data. As another example, the query comprises an image. As further described below in conjunction with FIGS. 3-5, the query includes a user intent, which may include a result from combining various items obtained from a retailer. For example, the query includes a name of a recipe or a description of a recipe. In another example, the query comprises an image of a result of an ingredient. The query may include additional information, such as timing information identifying when the user intends to create the result identified by the query, preferences of the user for items, or other contextual information relevant to selection of items.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user such that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provides portions of the payment from the user to the picker and the retailer.

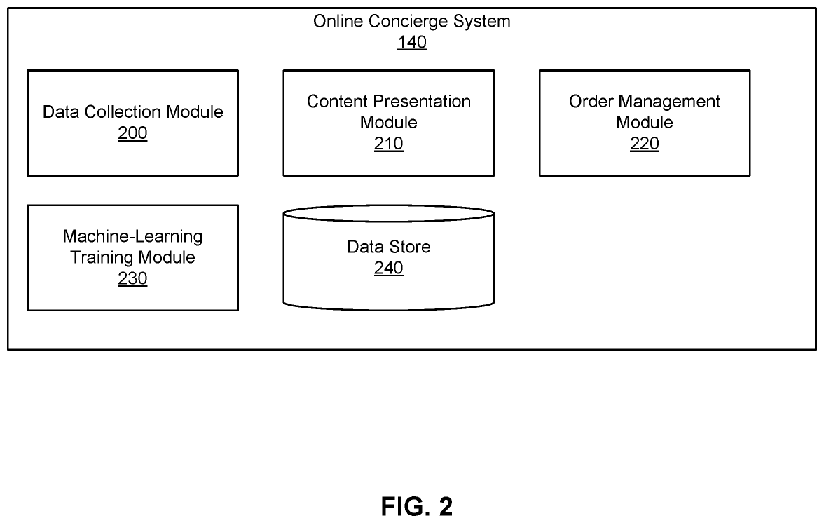

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is characteristics describing an order. For example, order data may include item data for items that are included in the order, a delivery location for the order, a user associated with the order, a retailer location from which the user wants the ordered items collected, a payment method used by the user to pay the online concierge system 140 for fulfilling the order, or a timeframe within which the user wants the order delivered. Order characteristics may further include information describing how the order was serviced, such as which picker serviced the order, when the order was delivered, or a rating that the user gave the delivery of the order.

The content presentation module 210 selects content for presentation to a user. For example, the content presentation module 210 selects which items to present to a user while the user is placing an order. The content presentation module 210 generates and transmits the ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the user client device 100. A search query is text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a user based on whether the predicted availability of the item exceeds a threshold.

In various embodiments, the content presentation module 210 generates and transmits instructions for generating an ordering interface to a user client device 100. The ordering interface includes one or more elements configured to receive a query from the user via the user client device 100. As further described below in conjunction with FIGS. 3-5, the query includes a result from combining various items obtained from a retailer. The query may comprise unstructured text. Alternatively, the query comprises one or more images. In other embodiments, the query includes text data and one or more images. As further described below in conjunction with FIGS. 3-5, based on the query, the content presentation module 210 generates an order form including characteristics of an order for obtaining items to combine for the result included in the query.

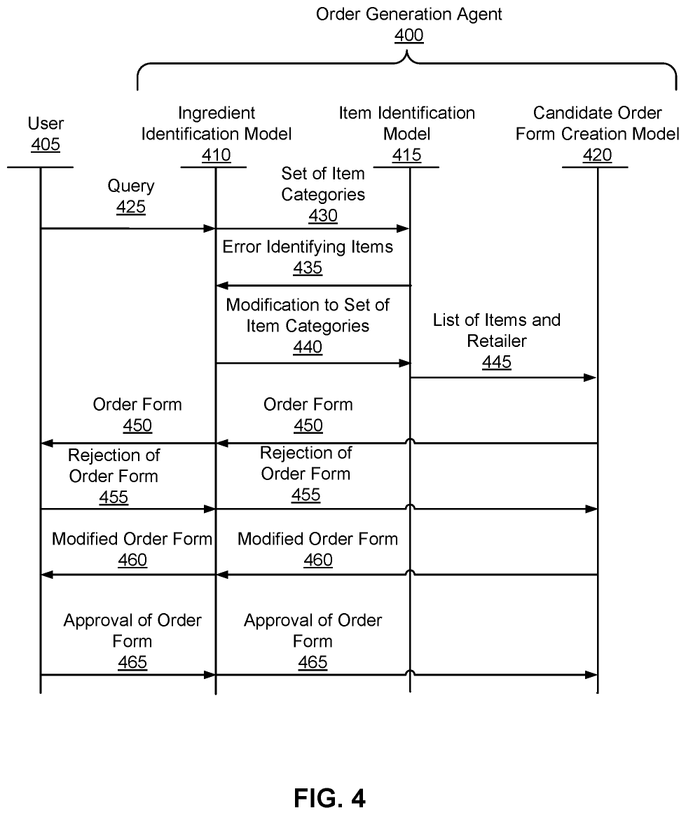

To generate the order form based on the received query, the content presentation module 210 inputs the received query from the user client device 100 to an order generation agent comprising multiple machine learning models. Based on output generated by each constituent machine learning model, the order generation model generates a list of items based on the query and characteristics of an order for obtaining the list of items. Different machine learning models comprising the order generation agent exchange data with each other, allowing one of the machine learning models to provide input to another machine learning model for generating a list of items or characteristics of an order, as further described below in conjunction with FIGS. 3 and 4. Hence, the order generation agent allows a user to specify a result from combining items, with the online concierge system 140 generating the items to create the result and characteristics of an order for obtaining the generated items via the order generation agent, reducing an amount of input the user provides the online concierge system 140 to create an order.

The order management module 220 manages orders for items from users. The order management module 220 receives orders from a user client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of their order. In some embodiments, the order management module 220 computes an estimated time of arrival for the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

In various embodiments, the machine learning training model 230 trains a plurality of models that are used in combination with each other to implement an order generation agent. One or more of the models comprising the order generation agent are generative models configured to receive a prompt including text or one or more images as input and to generate text data as output. For example, each of the generative models are large language models (LLMs) previously trained on a large text or image corpus and subsequently tuned using examples based on data included in the data store 240 to output specific types of data. For example, the machine learning training model 230 trains or tunes an ingredient identification model that receives a prompt including a result of combining items as input and generates a set of item categories including items for combination to create the result. As further described below in conjunction with FIG. 3, the machine learning training module 230 may generate ingredient examples each including a description of a recipe (e.g., a recipe name, a recipe description, an image associated with a recipe) and item categories corresponding to the recipe, and use the ingredient examples to tune the ingredient identification model to output the set of item categories based on a received prompt.

Additionally, the machine learning training module 230 tunes or trains a candidate order generation model comprising another generative model (e.g., an LLM) that receives a prompt including a list of items and a retailer and generates an order form including characteristics of an order for obtaining the item based on prior orders from a user. In various embodiments, the machine learning training module 230 tunes the order generation model using example orders previously received from a user. Each example order includes a prompt comprising an example set of items from a prior order, a retailer from which the prior order was fulfilled and characteristics of the prior order. The machine learning training module 230 retrieves prior orders from a user from the data store 240 to generate example orders specific to a user, so the characteristics of an order generated by the candidate order generation model are tailored to a particular user. Example characteristics of an order include items included in the order, the retailer from which the items are obtained, a time interval for delivering the items, a location where the items are to be delivered, a payment method for providing compensation to the online concierge system 140, or other information describing fulfillment of the order.

Additionally, the machine learning training model 230 trains or tunes an item identification model that receives a combination of an identifier of a retailer and a set of item categories as input and generates a list of items from the retailer that includes at least one item included in each item category of the set of item categories. Hence, the item identification model maps general item categories to corresponding specific items capable of being obtained from a retailer. In some embodiments, the item identification model comprises a generative model, such as an LLM, receiving a prompt including the set of item categories and an identifier of a retailer and generating one or more lists of items so each item category of the set of item categories is associated with a corresponding item in the list. A generative model comprising the item identification model may be tuned using ingredient examples that each identify a relationship between an item category and one or more items. Alternatively, the item identification model comprises a neural network or alternative model that receives an item category and a catalog of items as inputs and selects an item corresponding to the item category; in such embodiments, the item identification model is applied to each item category of the set of item categories to select an item from the catalog for each item category. As further described below in conjunction with FIG. 3, the item identification model may generate multiple lists of items in some embodiments, with each list of items including different items from a common retailer or with different lists of items corresponding to different retailers.

As further described below in conjunction with FIGS. 3-5, in various embodiments, the order generation agent receives a query from a user and applies the ingredient identification model to the query, generating a set of item categories for the query. The set of item categories generated by the ingredient identification model is included in a prompt received as input by the item identification model, which generates a list of items corresponding to the set of item categories and a retailer from which the list of items is obtained. A prompt including the list of items and an identifier of the retailer is then received by the candidate order form generation model, which generates an order form for a user including characteristics of an order for obtaining the items of the list based on prior orders fulfilled by the online concierge system 140 for the user.

The data store 240 stores data used by the online concierge system 140. For example, the data store 240 stores user data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart of a method for selecting items for an order and generating the order based on a query received from a user, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 receives 305 a query from a user through an interface. For example, the online concierge system 140 transmits instructions for generating an ordering interface to a user client device 100, which executes the instructions to generate the ordering interface for the user. The ordering interface includes an interface element where the user inputs the query, and the online concierge system 140 receives 305 the query from the user client device 100. In various embodiments, the query comprises unstructured text from the user. For example, the user enters text through one or more interface elements or input devices of the user client device 100. As another example, the user client device 100 captures audio data from the user and generates text comprising the query by applying one or more audio to text processes to the captured audio data. Alternatively, the query is an image the ordering interface receives from the user. For example, the user captures an image using a camera or another image capture device of the user client device 100, and the ordering interface receives the captured image. As another example, the user obtains an image from a storage device of the user client device 100 or from a third-party system via the user client device 100.

The query includes a result from combining various items. For example, the query comprises a description of a result from combining multiple items, such as a description or a name of a recipe. In a particular example, a query is text identifying a “cake” or is an image of a cake. In other embodiments, the query comprises alternative content describing a result from combining items. Having the query describe a result from combining items simplifies creation of the query, allowing the user to provide an intended result for multiple items rather than identify individual items. This reduces an amount of time for the user to create a query, by allowing the user to provide a query without knowing each item that is combined to create a result included in the query. For example, the query identifies a type of cake rather than one or more individual items used to create the cake.

The online concierge system 140 applies an order generation agent to the query. In various embodiments, the order generation agent comprises multiple trained models. Different models comprising the order generation agent may exchange data with each other, allowing a model included in the order generation agent to provide input or other information to one or more other models included in the order generation agent. The order generation agent includes an ingredient identification model, an item identification model, and a candidate order form creation model in various embodiments. Further, as the order generation agent accesses information associated with a retailer, such as a catalog of items offered by the retailer, in various embodiments the online concierge system 140 limits the order generation agent's access to information associated with retailers who have expressly granted such access to the order generation agent. For example, the online concierge system 140 stores an access permission in association with an identifier of a retailer based on an input received from the retailer and does not permit the order generation agent to access information associated with the retailer unless the access permission has a specific value. This provides different retailers with control over whether the order generation agent is capable of accessing information associated with the retailer and maintained by the online concierge system 140.

When applying the order generation agent to the query, the ingredient identification model initially generates 310 a set of item categories indicating ingredients to combine to create the result included in the query. Each item category of the set of item categories comprises an ingredient for creating the result included in the query. As further described above in conjunction with FIG. 2, an item category is a group of items with a similar type, where items in an item category may be considered to be equivalent to each other. An item category and items in the item category have a hierarchical relationship, with the item category specifying one or more common item attributes shared by one or more specific items in the item category. Hence, the set of item categories identifies a candidate pool of items from which the result corresponding to the query may be created.

The ingredient identification model comprises a generative model that receives the query as input and generates 310 the set of ingredients based on the query. In various embodiments, the ingredient identification model is a large language model pre-trained using unsupervised text from a text corpus or an image corpus. For example, the ingredient identification model is a generative pre-trained transformer model (GPT).

To refine the ingredient identification model to generate a set of item categories, the online concierge system 140 tunes the pre-trained large language model comprising the ingredient identification model based on a set of recipes the online concierge system 140 obtains from the data store 240 or from one or more third party systems. Each recipe has a recipe name, or a recipe description, and a set of item categories included in the recipe. Additionally or alternatively, a recipe may be associated with one or more images, such as images identifying a result from combining the set of item categories included in the recipe. In various embodiments, the online concierge system 140 generates a dataset including multiple ingredient examples based on the obtained recipes. Each ingredient example includes a description of a result of a recipe (e.g., a recipe name of a recipe, a recipe description of the recipe, or an image associated with the recipe) and a set of item categories associated with the recipe.

In various embodiments, the online concierge system 140 tunes the ingredient identification model using an ingredient index generated from the ingredient examples. Tuning the ingredient identification model includes one or more ingredient examples retrieved from the ingredient index in a prompt the ingredient identification model receives as input. An ingredient example includes information identifying a recipe (e.g., a recipe name, a recipe description, an image associated with a recipe) and a set of item categories associated with the recipe. To generate the index of ingredient examples, the online concierge system 140 generates an embedding for each ingredient example and stores the embeddings in the ingredient index. For example, the embedding for an ingredient example is based on a combination of a description of a recipe (e.g., a recipe name, a recipe description, an image associated with a recipe) and a set of item categories associated with the recipe. In various embodiments, each ingredient example corresponds to a different recipe or to a different description of a recipe so the ingredient index includes embeddings corresponding to various recipes.

The online concierge system 140 tunes the ingredient identification model based on the ingredient example by determining an embedding for the query. Based on the embedding for the query and embeddings for different item examples included in the ingredient index, the online concierge 140 selects one or more ingredient examples. For example, the online concierge system 140 determines measures of similarity (e.g., dot product, cosine similarity) between the embedding for the query and embeddings for various ingredient examples and selects one or more ingredient examples based on the measures of similarity. In some embodiments, the online concierge system 140 selects one or more ingredient examples with embeddings having at least a threshold measure of similarity to the embedding for the query or having at least a threshold position in a ranking of ingredient examples based on measures of similarity. The online concierge system 140 generates a prompt input to the ingredient identification model including the query and information describing the selected one or more ingredient examples (e.g., the selected ingredient examples, embeddings for the selected ingredient examples), so the ingredient identification model is applied to the query in conjunction with the information describing the selected one or more ingredient examples.

Alternatively or additionally, the online concierge system 140 tunes the ingredient identification model by applying the ingredient identification model to each ingredient example of the dataset. For example, the ingredient identification model receives an input prompt including information describing a receipt (e.g., a recipe name of a recipe, a recipe description of the recipe, or an image associated with the recipe) and generates a predicted set of item categories based on the input prompt. For each ingredient example, the online concierge system 140 scores the ingredient identification model using a loss function based on a difference between the predicted set of item categories output by the ingredient identification model when applied to an ingredient example and the set of item categories included in the ingredient example. In various embodiments, the score is an error term generated by the loss function. Example loss functions include a mean square error function, a mean absolute error, a hinge loss function, and a cross-entropy loss function.

The online concierge system 140 backpropagates the error term to update one or more parameters comprising the ingredient identification model and stops backpropagation in response to the error term, or in response to the loss function, satisfying one or more criteria. For example, the online concierge system 140 backpropagates the error term through the ingredient identification model to update parameters of the ingredient identification model until the error term has less than a threshold value. For example, the online system 140 may apply gradient descent to update the set of parameters. The online concierge system 140 stores the set of parameters comprising the tuned ingredient identification model on a non-transitory computer readable storage medium after stopping the backpropagation. Modifying one or more parameters of the ingredient identification model based on obtained recipes allows the pre-training of the ingredient identification model to be further refined so the ingredient identification model is optimized for identifying a set of item categories based on at least a portion of a received prompt based on associations between recipe names, recipe descriptions, images associated with recipes, and sets of item categories represented by the obtained recipes.

While the ingredient identification model generates 310 a set of item categories for the query, multiple items may correspond to each item category of the set of item categories. For example, an item category of “milk” includes multiple items that each correspond to different specific types of milk. As a retailer may offer multiple items within an item category or different retailers offer different items within an item category, the set of item categories output by the ingredient identification model are input to an item identification model included in the order generation agent. The item identification model generates 315 one or more lists of items corresponding to the set of item categories. For example, the item identification model receives a set of item categories and an identifier of a retailer as input and outputs a list of items from the retailer, with each item included in at least one item category of the set. The list of items generated 315 by the item identification model includes at least one item corresponding to each item category of the set of items. For example, if the set of item categories includes five item categories, the item identification model generates 315 a list including five items, with each item corresponding to an item category of the set of item categories.

In some embodiments, the item identification model outputs multiple lists of items, with each list of items including items corresponding to each item category of the set. This allows the item identification model to generate multiple candidate lists of items that account for different combinations of items offered by the retailer included in different item categories of the set. In some embodiments, the item identification model receives different combinations of the set of item categories and different identifiers of retailers as inputs, so the item identification model generates one or more lists of items offered by different retailers. For example, the order generation agent obtains a location associated with the user from a profile associated with the user in the data store 240, and identifies retailers within a threshold distance of the location associated with the user. Subsequently, the item identification model subsequently receives different combinations of the set of item categories from the ingredient identification model and identifiers of retailers within the threshold distance of the location associated with the user. The item identification model generates one or more lists of items corresponding to each retailer within the threshold distance of the location associated with the user in various embodiments.

In some embodiments, the item identification model is a generative model that receives the set of item categories and an identifier of a retailer as input and generates 315 one or more lists of items offered by the retailer that correspond to each item category of the set of item categories. In various embodiments, the item identification model is a large language model pre-trained using unsupervised text from a text corpus or an image corpus. For example, the item identification model is a generative pre-trained transformer model (GPT).

To refine the item identification model to output a list of items based on a prompt including a set of item categories and an identifier of a retailer, the online concierge system 140 tunes the item identification model based on data stored by the online concierge system 140 identifying items offered by different retailers. For example, the online concierge system 140 maintains a catalog for each retailer, with the catalog for a retailer identifying each item offered by the retailer along with corresponding item attributes for each item offered by the retailer. For example, the data store 240 includes a catalog associated with an identifier of a retailer identifying each item offered by the retailer and corresponding item attributes of each item offered by the retailer. In various embodiments, the online concierge system 140 generates an item dataset including multiple item examples based on the stored data identifying items offered by retailers. Each item example includes an item category and items offered by a specific retailer included in the item category in various embodiments.

In various embodiments, the online concierge system 140 tunes the item identification model using item examples each based on items offered by retailers. For example, an item example includes a prompt comprising a set of item categories and an identifier of a retailer along with a selected list of items from the retailer including at least one item corresponding to each item category of the set. In some embodiments, an item example includes one or more item attributes in association with each item of the selected list of items. Example item attributes included in an item example include a price of an item, a rate at which pickers found the item at the retailer when fulfilling prior orders, or other information about an item influencing fulfillment of an order including the item.

To tune the item identification model in various embodiments, the online concierge system 140 includes information about one or more item examples in a prompt that includes a combination of an identifier of a retailer and a set of item categories from the ingredient identification model. The prompt is received as input by the item identification model, so the item identification model receives information about an expected output from the information about one or more item examples in the prompt. The online concierge system generates 140 an item index including various item examples to simplify inclusion of an item example in a prompt. To generate the item index, the online concierge system 140 generates an embedding for each item example and stores the embeddings in the item index. For example, the embedding for an item example is based on a combination of an identifier of a retailer included in the item example, the set of item categories included in the item example, and the selected list of items included in the item example. The embedding for an item example may account for one or more item attributes of items included in the selected list of items of an item example in various embodiments.

The online concierge system 140 generates an embedding for the set of item categories from the ingredient identification model and the identifier of the retailer received by the item identification model and compares the embedding for the set of item categories and identifier of the retailer to each embedding for an item example stored in the item index. In various embodiments, the online concierge system determines measures of similarity (e.g., dot product, cosine similarity) between the embedding for the set of item categories and the identifier of the retailer and embeddings for item example. Based on the determined measures of similarity, the online concierge system 140 identifies one or more item examples similar to the set of item categories and the identifier of the retailer. For example, the online concierge system 140 selects an item example having an embedding with a maximum measure of similarity to the embedding for the set of item categories and identifier of the retailer. The online concierge system 140 subsequently generates a prompt for the item identification model by combining the set of item categories and the identifier of the retailer with information describing one or more selected item examples. In some embodiments, the prompt includes the set of item categories and the identifier of the retailer and embeddings for each of the selected item examples. Alternatively, the prompt includes the set of item categories and the identifier of the retailer in addition to text or other data from each of the selected one or more item examples. Hence, the online concierge system 140 tunes the item identification model to output a list of items from the retailer corresponding to the identifier of the retailer by augmenting the set of item categories and the identifier of the retailer with one or more selected item examples. This allows one or more selected item examples to provide the item identification model with additional context for selecting items from a retailer that are included in different item categories, allowing pre-training of the item identification model to be refined based on contextual relationships between item categories, retailers, and items offered by retailers based on data stored by the online concierge system 140.

Alternatively or additionally, the online concierge system 140 tunes the item identification model by applying the item identification model to each item example of the item dataset. For example, the item identification model receives an input prompt including a set of item categories and an identifier of the retailer from an item example and generates a predicted list of items where each item is offered by the retailer and each item category of the set has a corresponding item in the predicted list. For each item example, the online concierge system 140 scores the item identification model using a loss function based on a difference between the predicted list of items output by the item identification model when applied to an item example and the list of items included in the item example. In various embodiments, the score is an error term generated by the loss function. Example loss functions include a mean square error function, a mean absolute error, a hinge loss function, and a cross-entropy loss function.

The online concierge system 140 backpropagates the error term to update one or more parameters comprising the item identification model and stops backpropagation in response to the error term, or in response to the loss function, satisfying one or more criteria. For example, the online concierge system 140 backpropagates the error term through the item identification model to update parameters of the item identification model until the error term has less than a threshold value. For example, the online system 140 may apply gradient descent to update the set of parameters comprising the item identification model. The online concierge system 140 stores the set of parameters comprising the tuned item identification model on a non-transitory computer readable storage medium after stopping the backpropagation. Such modification of one or more parameters of the item identification model based on the item example allows refinement of pre-training of the item identification model using a larger training corpus so the item identification model generates a list of items offered by a retailer and a set of item categories identified to the item identification model.

In alternative embodiments, the item identification model comprises a model having an alternative architecture trained to select an item corresponding to an item category received as input. For example, the item identification model receives a catalog of items and an item category and generates an item selected from the catalog for the item category. For example, the item identification model is a neural network recurving a catalog of items and an item category as an input and generating an item from the item catalog included in the item category as output. Such an item identification model may be trained through backpropagation by application to a set of training examples each including a training item category and a training catalog to which a label identifying a training item is applied. Using backpropagation to train the item identification model is further described above, such as in conjunction with FIG. 2.

In some embodiments, the item identification model is tuned or trained to generate multiple lists of items and a corresponding list score for each list of items generated 315 based on a received set of item categories. For example, the online concierge system 140 obtains a predicted availability of each item offered by a retailer from application of a trained availability model, further described above in conjunction with FIG. 2, to each combination of item identifier and identifier of the retailer. The predicted availability of each item offered by the retailer is included in a prompt input to the item identification model including the identifier of the retailer and the set of item categories, so the item identification receives predicted availabilities of different items at the retailer. Based on predicted availabilities of items that the item identification model includes in a list of items for the set of item categories and the identifier of the retailer, the item identification model generates the list score for the list. In various embodiments, the list score is higher when a value based on a combination of predicted availabilities of items included in the list at the retailer is larger and is lower when the value based on the combination of predicted availabilities of items included in the list at the retailer. The item identification model generates list scores for each of a set of candidate lists in some embodiments, with different candidate lists including at least one different item for at least one item category of the set of item categories relative to another candidate list.

While generating list scores based on predicted availabilities of items included in a list accounts for variations in availability of different items included in a list of items, other item attributes also affect desirability or suitability of the user including various items in an order. In some embodiments, the item identification model receives multiple item attributes for each item offered by a retailer and generates a list score for a list of items from the retailer based on a combination of one or more item attributes of items included in the list. For example, the item identification model generates a value for each item included in the list based on a cost to the online concierge system 140 to obtain the item from the retailer and a predicted availability of the item at the retailer and generates the list score for the list by aggregating the values for each item of the list. In an example, the item identification model generates an expected cost to the online concierge system 140 for fulfilling each list based on an expected amount the online concierge system 140 spends to obtain the items from the retailer and accounts for the cost of obtaining items included in a list when determining a list score for the list. For example, the list score for a list is a cost to the online concierge system 140 of for fulfilling an order including the items in the list. As another example, the item identification model generates a list score for a list of items based on combinations of various item attributes of items in the list (e.g., based on predicted availability of each item of the list and an expected cost for the online concierge system 140 to obtain each item of the list).

In some embodiments, the item identification model outputs a specific list of items selected based on corresponding list scores and an identifier of a retailer corresponding to the specific list of items. For example, the item identification model generates multiple candidate lists, each associated with an identifier of a retailer, for each combination of the set of item categories and retailers within a threshold distance of a geographic location of the user. As another example, the item identification model generates multiple candidate lists each associated with a common identifier of a retailer to account for different combinations of items from the retailer corresponding to each item category of the set of item categories. Based on the list scores for the candidate lists, the item identification model selects a specific list. For example, the item identification model ranks candidate lists based on their list scores and selects a specific list of items having a threshold position in the ranking or having a maximum position in the ranking. Alternatively, the item identification model selects one or more lists of items having less than a threshold position in the ranking or having a minimum position in the ranking. As another example, the item identification model selects a group of lists based on their list scores, such as lists having at least a threshold position in a ranking of candidate lists based on corresponding list scores. The item identification model may output a list score corresponding to one or more specific lists of items along with the one or more specific lists of items in some embodiments to provide information about the specific lists along with the specific lists.

Based on the set of item categories from the ingredient identification model and a location associated with the user, the item identification model generates one or more lists of items from a retailer including an item corresponding to each item category of the set of item. As further described above, the item identification model may output a single specific list and corresponding identifier of a retailer or may output multiple specific lists each associated with an identifier of a corresponding retailer. Hence, the item identification model generates specific items to obtain from a retailer based on the set of item categories generated by the ingredient identifier, narrowing the set of item categories into a list of specific items a picker may obtain from a retailer creating a list of specific items so the list of items includes a specific item corresponding to each item category of the set of item categories.

The order generation agent applies the candidate order form creation model to the list of items generated by the item identification model and corresponding identifier of a retailer to generate 320 an order form including characteristics of an order for obtaining the items included in the list from the retailer corresponding to the identifier of the retailer. The order form includes different characteristics of an order, such as identifiers of each item of the list of items, the identifier of the retailer from which the items are to be obtained, a time interval for delivering the items to the user, a location for delivering the items, a payment method used to compensate the online concierge system 140, or other information describing fulfillment of an order for the items of the list of items. In various embodiments, the candidate order form creation model is a generative model that receives a prompt including the list of items from the item identification model and the identifier of the retailer corresponding to the list of items. The prompt may also include metadata associated with the user. The metadata may be extracted from the query by the ingredient identification model in some embodiments. For example, the ingredient identification model extracts contextual information identifying timing for fulfillment of an order to the user from the query as metadata. Alternatively or additionally, the candidate order form generation model obtains metadata from data in the data store 240 associated with the user. For example, the metadata includes one or more item attributes of items included in orders previously fulfilled for the user, payment methods previously used by the user for previously fulfilled orders, characteristics of orders associated with different payment methods, or other information describing orders the online concierge system 140 previously fulfilled for the user. The candidate order form creation model 320 generates the order form based on the list of items, the identifier of the retailer, as well as metadata, if any, included in the prompt.

In various embodiments, the candidate order form creation model is a generative model that receives the list of items, an identifier of a retailer, and may receive metadata extracted from the query or retrieved from the data store 240 and generates 320 an order form including characteristics of an order for obtaining the items included in the list of items from the retailer. The order form includes the items from the list of items, the retailer corresponding to the identifier of the retailer, a time interval for fulfilling the order, a total price of items included in the list to the user, a location for a picker to deliver the items included in the list, a payment method for the order, and may include additional information describing the order. In various embodiments, the candidate order form creation model is a large language model pre-trained using unsupervised text from a text corpus or an image corpus. For example, the item identification model is a generative pre-trained transformer model (GPT).

To refine the candidate order form creation model to generate 320 the order form including characteristics of an order for obtaining items from the list of items from an identified retailer, the online concierge system 140 tunes the candidate order form creation model using prior orders the online concierge system 140 fulfilled for the user. For example, the online concierge system 140 stores prior orders created by the user and fulfilled by the online concierge system 140/Stored data for a prior order includes items included in the prior order, a retailer from which the items were obtained, a time interval during which the prior order was fulfilled, a location where items in the prior order were delivered, a payment method for compensating the online concierge system 140 for the prior order, or other descriptive information about the prior order. In various embodiments, the online concierge system 140 generates an order dataset including multiple example orders based on the prior orders stored in association with the user.

In various embodiments, the online concierge system 140 tunes the candidate order form creation model using example orders that are each based on a prior order stored in association with the user. An example order includes a prompt comprising an example set of items from a prior order, a retailer from which the prior order was fulfilled and information describing the prior order including the example set of items fulfilled at the retailer. The prompt of an example order may include additional information in various embodiments.

Tuning the candidate order form creation model, in various embodiments, includes information about one or more example orders in a prompt for the candidate order form creation model that also includes the list of items and identifier of a retailer from the item identification model. This allows the candidate order form creation model to leverage information from the example order indicating relationships between a list of items and characteristics of a prior order when generating the order form based on the list of items and the identifier of the retailer. To include an example order in a prompt for the candidate order form creation model, the online concierge system 140 generates an order index that includes information from different example orders in various embodiments. For example, the online concierge system 140 generates an embedding for each example order and stores the embeddings in the order index. For example, the embedding for an example order is based on the items included in the prior order corresponding to the example order, a retailer from which the prior order was fulfilled, a time interval when the prior order was fulfilled, a location where items from the prior order were delivered, a payment method used for the prior order, or other characteristics of the prior order. In various embodiments, the online concierge system 140 generates an order index for different users, so an order index for a user is based on prior orders the online concierge system 140 stored in association with the user.

When applying the candidate order form creation model to a list of items and an identifier of a retailer, the online concierge system 140 generates a list embedding for the list of items and the identifier of the retailer from the item identification model, and may account for metadata from the query when generating the list embedding. The online concierge system 140 compares the list embedding to each embedding for an example order stored in the order index. For example, the online concierge system 140 determines a measure of similarity between the list embedding and each embedding for an example order in the order index. Based on the measures of similarity, the online concierge system 140 selects one or more example orders. For example, the online concierge system 140 selects an example order having an embedding with a maximum measure of similarity (e.g., cosine similarity, dot product) to the list embedding. As another example, the online concierge system ranks the example orders of the index based on their measures of similarity to the list embedding and selects one or more example orders having at least a threshold position in the ranking. The online concierge system 140 subsequently tunes the candidate order form creation model by generating a prompt that combines the one or more selected example orders with the list of items and the identifier of the retailer from the item identification model. In some embodiments, the prompt includes the list of items and the identifier of the retailer in conjunction with the embedding of the selected example order. Alternatively, the prompt includes the list of items and the identifier of the retailer in addition to text data, or other data, from each of the selected one or more example orders. Hence, the online concierge system 140 tunes the candidate order form creation model to output an order form including characteristics of an order for obtaining the items from the list of items from the retailer that leverages information about one or more example orders by augmenting the list of items and the identifier of the retailer with one or more selected example orders. This allows the candidate order form creation model to leverage information about one or more example orders included in the prompt to generate information for an order to obtain items from the list of items from the retailer. This refines pre-training of the item identification model to generate 320 an order form for obtaining the items from the list of items from the retailer based on a prior order history for the user.

Alternatively or additionally, the online concierge system 140 tunes the candidate order form creation model by applying the candidate order form creation model to each example order of the order dataset. For example, the candidate order form creation model receives an input prompt including a list of items and an identifier of a retailer from an example order and generates a predicted order form including characteristics of an order for obtaining the list of items in the example order from the retailer identified by the example order. For each example order, the online concierge system 140 scores the candidate order form creation model using a loss function based on a difference between the predicted order form and characteristics of a prior order corresponding to the example order. In various embodiments, the score is an error term generated by the loss function. Example loss functions include a mean square error function, a mean absolute error, a hinge loss function, and a cross-entropy loss function.

The online concierge system 140 backpropagates the error term to update one or more parameters comprising the candidate order form creation model and stops backpropagation in response to the error term, or in response to the loss function, satisfying one or more criteria. For example, the online concierge system 140 backpropagates the error term through the candidate order form creation model to update parameters of the item identification model until the error term has less than a threshold value. For example, the online system 140 may apply gradient descent to update the set of parameters comprising the candidate order form creation model. The online concierge system 140 stores the set of parameters comprising the tuned candidate order form creation model on a non-transitory computer readable storage medium after stopping the backpropagation. Such modification of one or more parameters of the candidate order form creation model based on the example orders allows refinement of pre-training of the candidate order form creation model from a larger training corpus so the item identification model based on specific data describing prior orders from the user to generate characteristics of an order based on a list of items and an identifier of a retailer.

The order form generated 320 by the candidate order form creation model comprises characteristics of an order for obtaining the list of items that the item identification model generated 315 based on a set of item categories generated 310 based on the query from the user. This allows the order generation agent to generate 310 a set of item categories based on the query from which a list of specific items corresponding to the set of item categories is generated 315. Based on the list of items and prior orders fulfilled for the user, the order agent model also generates 320 an order form specifying characteristics of an order for obtaining the list of items. Hence, the order generation agent identifies a list of items and characteristics of an order for obtaining the list of items from a query specifying a result from combining items, simplifying creation of an order for items to combine for the result.

As the order generation agent includes multiple models, different models comprising the order generation agent exchange status information or other information with each other to generate 320 the order form based on the received query or to generate other information. FIG. 4 shows an interaction diagram showing data exchange between models comprising the order generation agent to illustrate an example exchange of data between different models comprising the order generation agent. For purposes of illustration, FIG. 4 shows an example where the order generation agent 400 receives data from a user 405, while in other embodiments the order generation agent 400 receives data from another source. The order generation agent 400 shown in FIG. 4 comprises an ingredient identification model 410, an item identification model 415, and a candidate order form generation model 420. However, in other embodiments, the order generation agent 400 includes different or additional models than those shown in the example of FIG. 4.

The order generation agent 400 executes on an online concierge system 140, as further described above in conjunction with FIGS. 2 and 3. The online concierge system 140 receives a query 425 from the user 405. For example, the user 405 enters the query 425 in an ordering interface or other interface presented by a user client device 100, which transmits the query 425 to the online concierge system 140. In various embodiments, the query 425 identifies a result from combining items. For example, the query 425 is a name of a recipe, a description of a recipe made from combining items, an image of a result from combining items, or other descriptive information of a result from combining various items. The online concierge system 140 includes the query 425 in a prompt that is input to the ingredient identification model 410 of the order generation agent 400.

As further described above in conjunction with FIG. 3, the ingredient identification model 410 is a generative model, such as a large language model, tuned or trained using recipes obtained by the online concierge system 140. Each recipe includes descriptive information for the recipe, such as a recipe name, a recipe description, or one or more image associated with the recipe, and a group of item categories corresponding to items combined by the recipe, Tuning or training the ingredient identification model 410 using obtained recipes configures the ingredient identification model 410 to generate a set 430 of item categories corresponding to a query. Each item category of the set 430 of item categories corresponds to one or more items, so combining an item in each item category of the set 430 of item categories creates the result identified by the query 425. However, multiple items offered by a retailer may correspond to each item category. For example, an item category of “bread” includes different items that have different item attributes (e.g., different types of bread).

The set 430 of item categories identifies a subset of items offered by retailers to include an order based on the query 425, but does not identify specific items capable of being obtained from a retailer by a picker. To identify specific items for the query 425, the order generation agent 400 generates a prompt for the item identification model 415 that includes the set 430 of item categories. In various embodiments, the prompt for the item identification model 415 includes additional information providing additional context for the set 430 of item categories. For example, the order creation agent 400 retrieves one or more preferences of the user 405 from a profile associated with the user 405 or that the user 405 included in the query. A preference for the user may identify one or more specific item attributes stored in a profile for the user or may identify one or more specific item attributes based on prior orders fulfilled by the online concierge system 140 for the user 405. Alternatively or additionally, the additional information may be extracted from the query 425 by the ingredient identification model 410, which is communicated to the item identification model 415 via the prompt including the set 430 of item categories.

As further described above in conjunction with FIG. 3, based on the prompt including the set 430 of item categories (and optionally including metadata) generated by the ingredient identification model 410, the item identification model 415 generates one or more lists 445 of items with each list 445 of items associated with a corresponding retailer. A list 445 of items includes multiple items offered by a retailer, with each item category of the set 430 of item categories including at least one item on the list 445 of items. Hence, the list 445 of items includes an item offered by a retailer that corresponds to each item category of the set 430 of item categories. For example, the set 430 of item categories includes item categories of “meat,” “cheese,” and “bread,” so a list 445 of items generated by the item identification model 415 includes a specific item in the “meat” item category, a specific item in the “cheese” item category, and a specific item in the “bread” item category. The list 445 of items generated by the item identification model 415 maps the broader item categories of the set 430 of item categories to corresponding specific items a picker is capable of obtaining from a retailer.

The item identification model 415 receives an identifier of a retailer in the prompt with the set 430 of item categories, so a generated list 445 of items is based on items offered by the retailer. As further described above in conjunction with FIG. 3, in various embodiments, the order generation agent 400 retrieves a location associated with the user 405 from a profile for the user stored in a data store 240 and identifies retailers within a threshold distance of the location associated with the user 405. The order generation agent 400 generates multiple prompts for the item identification model 415 that each include the set 430 of item categories and an identifier of a different identified retailer to generate multiple lists 445 of items for different retailers within the threshold distance of the location associated with the user 405. In some embodiments, the item identification model 415 generates multiple lists 445 of items, with different lists 445 corresponding to different retailers or including different combinations of items corresponding to the set 430 of item categories offered by a retailer.

However, the item identification model 415 may be unable to identify an item offered by a retailer that is included in an item category of the set 430 of item categories. For example, a retailer within a threshold distance of a location associated with the user 405 does not offer an item included in one item category of the set 430 of item categories. As another example, no retailer within the threshold distance of the location associated with the user 405 offers an item included in a specific item category of the set 430 of item categories. In response to the item identification model 415 being unable to identify at least one item included in an item category of the set 430 of item categories, the item identification model 415 transmits an error 435 to the ingredient identification model 410. In various embodiments, the error 435 is a prompt identifying an item category for which the item identification model 415 was unable to identify at least one item.

In response to receiving the error 435, the ingredient identification model 410 determines a modification 440 to the set 430 of item categories. In some embodiments, the ingredient identification model 410 generates one or more messages for presentation to the user 405 based on the received error 435. For example, the ingredient identification model 410 selects one or more alternative item categories for an item category identified by the error 435 and communicates a message identifying one or more of the alternative item categories to the user 405 to a user client device 100 for display along with a request for the user 405 to select one or more of the alternative item categories. The message may indicate that one or more items for creating the result in the query were unable to be located to provide context for the request for the user 405 to select an alternative item category. Alternatively, the ingredient identification model 410 selects an alternative item category for the item category identified by the error 435 without receiving a selection from the user 405. This allows the ingredient identification model 410 to determine a status of the item identification model 415 in generating a list 445 of items and to perform one or more actions based on the determined status. Receiving an error 435, or another type of status identifier, from the item identification model 415 provides the ingredient identification model 410 with feedback from the item identification model 415 and enables subsequent modification of the item identification model 415 based on the error 435 or other feedback. The ingredient identification model 410 communicates a modification 440 to the set 430 of item categories in response to the error 435 to the item identification model 415, which generates the list 445 of items based on the modified set 430 of item categories.

While the item identification model 415 generates at least one list 445 of items that, when combined, allow creation of the result included in the query 425, identifying the items does not specify how the items are to be obtained and delivered to the user 405. To generate characteristics for an order obtaining the items on the list 445 of items, the candidate order form creation model 420 receives a prompt from the item identification model 415 that includes the list 445 of items and a retailer, as further described above in conjunction with FIG. 3. Based on the received prompt, the candidate order form creation model 420 generates an order form 450 specifying characteristics of an order to obtain the items on the list 445 from the retailer. For example, the order form 450 identifies the items included in the list 445 of items, identifies the retailer from which the items are to be obtained, identifies a location where the items are to be delivered, identifies a time interval during which the items are to be delivered to the user 405, identifies a payment method for obtaining the items, or identifies other information describing an order for obtaining the items of the list 445 from the retailer. The prompt from which the candidate order form creation model 420 generates the order form 450 may include additional metadata, such as preferences associated with the user 405 by the online concierge system 140, that the candidate order form creation model 420 leverages to generate characteristics of an order included in the order form 450. The metadata may be extracted from the query 425 by the ingredient identification model 410 and included in the prompt in some embodiments. Alternatively or additionally, metadata is retrieved from prior orders the online concierge system 140 previously fulfilled for the user 405 and stored in association with the user 405.

In various embodiments, the candidate order form creation model 420 provides the order form 450 to the ingredient identification model 410, which generates a message presenting the order form 450 to the user 405. If the characteristics included in the order form 450 are satisfactory to the user 405, the user 405 transmits an approval 465 to the ingredient identification model 410. For example, the user 405 selects a specific input via an ordering interface displayed by a user client device 100 or provides a specific approval message or approval instruction to the ingredient identification model 410 via the user client device 100. The ingredient identification model 410 provides the approval 465 as an input to the candidate order form creation model 420, which generates an order based on the characteristics included in the order form 450.

However, when reviewing the order form 450, the user 405 may identify one or more characteristics of the order to modify. For example, the user 405 determines an alternative time interval for fulfilling the order is more suitable than the time interval included in the order form 450. To simplify modification of the order form 45 by the user, the ingredient identification model 410 receives a rejection 455 of the order form 450 from the user 405 via the user client device 100. For example, the user 405 enters a rejection message via an ordering interface of the user client device 100 that is communicated to the ingredient identification model 410. The rejection may be unstructured text in various embodiments. The rejection 455 identifies one or more characteristics specified by the order form 450 that are rejected by the user 405. In some embodiments, the rejection 455 also includes information for modifying the identified one or more characteristics. For example, if the user 405 rejects a time interval for fulfilling the order, the rejection 455 includes information identifying the time interval as being rejected and an indication whether an earlier time interval or a later time interval would be more suitable for the user 405.

Similarly, the rejection 455 may identify one or more items included in the list 445 of items to modify. In response to receiving a rejection 455 identifying one or more items, the ingredient identification model 410 provides a modification prompt to the item identification model 415 that identifies one or more items selected by the user 405. In response to receiving the modification prompt, the item identification model 415 generates an alternative item to replace an item included in the modification prompt, as further described above. For example, the modification prompt includes an identifier of an item to replace, an item category corresponding to the item to replace, and a retailer. Based on the modification prompt, the item identification model 415 generates an alternative item for the item to replace, causing generation of a modified list 445 of items including the alternative item rather than the item to replace. The item identification model 415 transmits the modified list 445 of items to the candidate order form creation model 420 as a prompt, causing the candidate order form creation model 420 to generate a modified order form 460 based on the modified list 445 of items.

The ingredient identification model 410 provides a prompt to the candidate order form creation model 420 including the rejection 455 from the user 405. In response to the rejection 455, the candidate order form creation model 420 generates a modified order form 460 where one or more characteristics of the order are modified based on the rejection 455. For example, the modified order form 460 includes a different time interval for fulfilling the order or includes a different payment method for the user 405 to pay for the order in response to the prompt including the rejection 455. The candidate order form creation model 420 provides the modified order form 460 to the ingredient identification model 410, which presents the modified order form 460 to the user 405 via an ordering interface. For example, the ingredient identification model 410 generates a message identifying the changes to one or more characteristics in the modified order form 460 for presentation to the user 405. As another example, the ingredient identification model 410 generates a message including the characteristics included in the modified order form 460 for presentation to the user 405.

The user 405 may provide an approval 465 of the modified order form 460 to the ingredient identification model 410, as further described above. In response to receiving the approval 465, the ingredient identification model 410 provides a prompt including the approval 465 to the candidate order form creation model 420, which generates an order based on the modified order form 460 in response to the approval 465, as further described above. This allows the user 405 to communicate with the order generation agent 400 to refine characteristics of the order form 450 prior to the order generation agent 400 generating an order for the user 405. The user 405 may iteratively provide information to the order generation agent 400 to refine one or more characteristics included in an order form 450 prior to creation of a corresponding order by iteratively providing different rejections 455 of an order form 450 presented to the user 405, as further described above.

Referring back to FIG. 3, the online concierge system 140 transmits 325 the order form generated by the order generation agent to the user client device 100 of the user. In response to receiving the order form, the user client device 100 displays or otherwise presents the order form, or presents characteristics of an order corresponding to the order form. Presenting the order form allows the user to review the characteristics of the order and the items included in the order from the order generation agent to verify that the items and the characteristics of the order are satisfactory to the user. Based on presentation of the order form to the user, the online concierge system 140 determines 330 whether approval of the order form is received from the user. In various embodiments, the online concierge system 140 receives an approval message from the user client device 100 in response to the user approving the order form.

In response to determining 330 the user approved the order form (e.g., receiving the approval message from the user client device 110), the online concierge system 140 provides an indication of approval to the order generation agent. Responsive to receiving the indication of approval, the order generation agent generates 335 an order for the user based on the order form. The generated order includes the list of items received by the candidate order form generation model, identifies the retailer received by the candidate order form generation model, includes a time interval for fulfilling the order determined by the candidate order form generation model, includes a location for delivering the items of the list of items determined by the candidate order form generation model, includes a payment method for the order, and includes other characteristics generated by the candidate order form generation model. Subsequently, the online concierge system 140 allocates the generated order to a picker for fulfillment. Hence, the order generation agent generates a list of items, identifies a retailer from which the list of items are obtained, and generates other characteristics for the order based on the query received 305 from the user. The output of the order generation agent is used to generate 335 a corresponding order, allowing the order to be generated 335 based on the result of a combination of items specified by the query. This reduces an amount of interaction by the user with the online concierge system 140 to generate an order. For example, rather than manually search items offered by a retailer and select individual items for inclusion in the order, the order generation agent receives a query identifying a result from a combination of items and generates a list of items for creating the identified result and generates characteristics of an order to obtain the list of items from a retailer.

However, the user may initiate modification of the order form by the order generation agent by providing a rejection of the order from to the online concierge system 140 via the user client device 100. In response to receiving a rejection from the user client device 100, the online concierge system 140 determines 330 the user does not approve the order form. In various embodiments, the rejection identifies one or more modifications to the order form. The rejection includes information describing one or more modifications in various embodiments. For example, the rejection includes information indicating a time interval earlier than or later than a time interval included in the order form or identifies an item in the order form to replace. The order generation agent generates a prompt based on the rejection that is input to the candidate order form creation model or to the item identification model. Based on the prompt, the candidate order form creation model generates 320 a modified order form with one or more characteristics of the order modified based on rejection of the order form by the user. For example, a rejection specifies an alternative time interval for fulfilling the order, and the candidate order form creation model generates a modified order form constrained by the alternative time interval. As another example, a rejection specifies a an item to replace, so the item identification model selects an alternative item included in a common item category as the item to replace and inputs a prompt including the alternative item to the candidate order form creation model, which generates a modified order form including the alternative item in place of the item to be replaced. A rejection received from the user may identify one or more alternative characteristics for the order or parameters for an alternative characteristic of the order, which the order generation agent (e.g., the item identification model, the candidate order form creation model) uses to generate 320 a modified order form that is transmitted 325 to the user client device 100 for presentation to the user.

As further described above, the user may transmit an approval of the modified order form to the online concierge system 140. In response to determining 330 the user approves the modified order form, the order generation agent generates 335 an order having characteristics specified by the modified order form. Alternatively, the user may transmit an additional rejection of the modified order form to the online concierge system 140. In response to determining 330 the user does not approve the modified order form, the order generation agent generates 320 an alternative order form based on the additional rejection of the modified order form, as further described above. Subsequently, the online concierge system 140 transmits 325 the alternative order form to the user client device 100 for review by the user. This allows the order generation agent to iteratively modify the order form based on modifications specified by the user based on review of the order form.

In alternative embodiments, the online concierge system 140 generates 335 an order having the characteristics included in the order without receiving an input from the user. For example, the user includes a setting in a profile associated with the user authorizing the online concierge system 140 to generate 335 an order from an order form without receiving approval from the user. Allowing the online concierge system 140 to automatically generate an order based on characteristics in a generated order form further simplifies generation of an order 335 by further reducing an amount of input the user provides the online concierge system 140 for order generation.

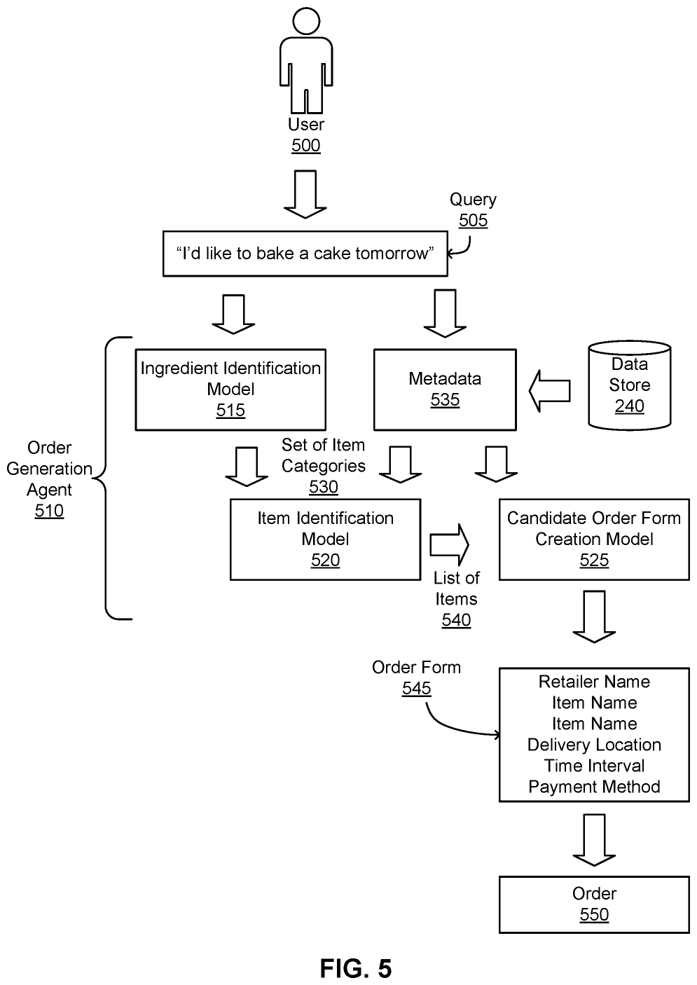

FIG. 5 is a process flow diagram of one embodiment of a method for an order generation agent executing on an online concierge system 140 selecting items for an order in response to a received query from a user. A user 500 creates an order via an online identifies items to be obtained, a retailer from which the items are to be obtained, and other characteristics describing the order. Various characteristics of the order describe how items are to be obtained to fulfill the order. Example characteristics of an order include item identifiers of items for a picker to obtain, an identifier of a retailer from whom the items are obtained, a delivery location where the picker delivers the item, a time interval for the picker to deliver the items to the delivery location, and a payment method for the picker providing compensation for the items. However, different or additional characteristics may be included in an order in various embodiments.

Conventionally, the user 500 generates an order by identifying a retailer to the online concierge system 140 and selecting individual items offered by the retailer for inclusion in the order. For example, an application associated with the online concierge system 140 executing on a user client device 100 displays one or more ordering interfaces to the user 500, and the user 500 provides search terms or other information for identifying items to the online concierge system 140 via an ordering interface. The one or more ordering interfaces display items identified from a retailer based on the search terms or other information, and the user 500 individually selects one or more of the identified items for inclusion in an order through an ordering interface. Hence, conventional order generation methods have the user provide multiple inputs to the online concierge system 140 and navigate through various ordering interface via the user client device 100.

To reduce an amount of user interaction with the online concierge system 140 by a user when creating an order, the online concierge system 140 receives a query 505 from the user 500 via an ordering interface. For example, an ordering interface displayed by the user client device 100 includes a search box or other interface element where the user 500 enters the query 505, which is transmitted from the user client device 100 to the online concierge system 140. In various embodiments, the query 505 comprises unstructured text, such as the statement “I'd like to bake a cake tomorrow” in the example of FIG. 5, including a result from combining multiple items. In the example of FIG. 5, the query 505 identifies “cake” as a result from combining different items. Alternatively, the query 505 comprises an image of a result of a combination of items obtained from a retailer. Additional information, such as timing information for the user creating the result identified by the query, specific item attributes of items to combine to create the result, or other information relevant to obtaining items for the result identified by the query may be included in the query in various embodiments.

The online concierge system 140 applies an order generation agent 510, as further described above in conjunction with FIGS. 3 and 4, to the query 505 to select items to obtain so a combination of the selected items creates the result included in the query. The order generation agent 510 also generates characteristics for an order to obtain the selected items for the user 500. This allows the user 500 to leverage the order generation agent 510 to select items and generate an order for the selected items based on content of the query 505 rather than individually identify and select discrete items for inclusion in an order and specify different characteristics for the order.

In various embodiments, the order generation agent 510 includes multiple models that exchange information with each other, with information from a model included in the order generation agent 510 being used by another model included in the order generation agent 510 to generate additional information, as further described above in conjunction with FIGS. 3 and 4. The example shown by FIG. 5 includes an order generation agent 510 comprising an ingredient identification model 515, an item identification model 520, and a candidate order form creation model 525. However, in other embodiments, the order generation agent 510 includes a different number of models than the example shown by FIG. 5.

As further described above in conjunction with FIGS. 3 and 4, the ingredient identification model 515 receives the query 505 as an input and generates a set 530 of item categories based on the query 505. Each item category of the set 530 corresponds to one or more items, so a combination of different items corresponding to different item categories of the set 530 allows the user 500 to create the result identified by the query 505. By combining an item in each item category of the set 530 of item categories generated by the ingredient identification model 515, the user 500 may create the result identified by the query 505. However, multiple items may correspond to each item category. For example, an item category of “cheese” includes different items that have different item attributes (e.g., different types of cheese, different quantities of cheese, etc.).

In various embodiments, the ingredient identification model 515 is a generative model initially trained on a large corpus of text or images and subsequently tuned to generate the set 530 of item categories based on recipes obtained by the online concierge system 140. As further described above in conjunction with FIG. 3, a recipe includes a combination of item categories and instructions for combining items included in the item categories to generate a result, which is identified by a recipe name, a recipe description, or an image associated with the recipe. Tuning the ingredient identification model 515 based on the recipes obtained by the online concierge system 140 allows the ingredient identification model 515 to leverage contextual relationships between item categories formed from their inclusion in recipes to generate a set 530 of items based on a result from combining items identified in the query 505. As further described above in conjunction with FIG. 3, the online concierge system may tune the ingredient identification model 515 in various embodiments by generating a prompt including the query 505 and one or more ingredient examples selected based on the query 505 to which the ingredient identification model 515 is applied. Each ingredient example includes information identifying a recipe and a set of item categories associated with the recipe, allowing the ingredient identification model 515 to leverage contextual relationships between a description of a recipe and item categories when generating the set 530 of item categories.

The ingredient identification model 515 may also extract metadata 535 from the query 505. For example, the ingredient identification model 515 extracts timing information from the query 505 including information describing an intended time for order fulfillment or a speed at which the user 500 expects to receive items based on the query 505. Other metadata 535 extracted from the query 505 may include one or more preferences for items by the user 500, dietary restrictions of the user 500, one or more item attributes for items to combine to generate the result, or other characteristics of the user 500 affecting items that the user 500 historically obtained. The ingredient identification model 515 may be tuned to extract metadata 535 through application to various examples or may be trained to extract metadata 535 through its initial training on a corpus of text or images.

Alternatively or additionally, the order generation agent 510 obtains metadata 535 associated with the query 505 by retrieving characteristics associated with the user 500 stored in the data store 240. For example, the order generation agent 510 obtains preferences or dietary restrictions of the user 500 from a profile stored in the data store 240 in association with the user. As another example, the order generation agent 510 obtains one or more attributes of items previously obtained by the user 500 from historical orders fulfilled for the user 500 by the online concierge system 140 and stored in the data store 240. In some embodiments, the order generation agent 510 retrieves a subset of metadata 535 from the data store 240, while the ingredient identification model 515 extracts additional metadata 535 from the query 505. Different metadata 535 may be extracted or obtained for different users 500 or in response to receiving different queries 505 in various embodiments.

The order generation agent 510 applies the item identification model 520 to the set 530 of item categories to generate one or more lists 540 of items. In various embodiments, a list 540 of items generated by the item identification model 520 includes multiple items, with each item included in at least one item category 530 of the set of item categories 530 and the list 540 of items including at least one item included in each item category 530 of the set of item categories. For example, the set of item categories 530 includes item categories of “eggs,” “flour,” “sugar,” “milk,” and “baking soda,” so a list 540 includes a specific type of egg, a specific type of flour, a specific type of sugar, a specific type of milk, and a specific type of baking soda. The item identification model 520 maps each item category in the set 530 of item categories to a specific item offered by a retailer for a picker to obtain. In various embodiments, the list 540 of items is associated with a retailer from which the items included in the list 540 of items are to be obtained. The item identification model 520 may receive metadata 535, such as preferences of the user 500 as input along with the set 530 of item categories and use the received preferences when generating the list 540 of items based on the set 530 of item categories. For example, the ingredient identification model 515 generates a prompt including the set 530 of item categories and optionally including metadata 535 that the item identification model 520 receives as input.

As further described above in conjunction with FIG. 3, the item identification model 520 is a generative mode, such as a large language model, trained on a large corpus of text and tuned based on catalogs of items offered by different retailers and identified relationships between items and item categories. Tuning of the item identification model 520 leverages identified relationships between items offered by a retailer and item categories to determine which items offered by the retailer are included in different item categories. However, in other embodiments, the item identification model 520 comprises an alternative type of model trained to select an item corresponding to an item category based on characteristics of the user 500 and items offered by a retailer. For example, the item identification model 520 is a neural network configured to receive an item category and a catalog of items as input and to output an item from the catalog included in the item category based on item attributes of items from the catalog. Hence, the item identification model 520 maps the more general item categories of the set 530 of item categories to specific items capable of being obtained from a retailer by a picker.

In some embodiments, the item identification model 520 generates a single list 540 of items selected from multiple candidate lists of items that each include different combinations of items based on the set 530 of item categories from a retailer. Different candidate lists may correspond to different retailers, such as different retailers within a threshold distance of a location associated with the user 500. Alternatively or additionally, different candidate lists may correspond to different items offered by a retailer generated for a particular item category of the set 530 of item categories. As further described above in conjunction with FIG. 3, the item identification model 520 selects the list 540 of items by determining a list score for each candidate list and selecting one or more lists 540 of items based on the corresponding list scores. For example, the item identification model 520 ranks candidate lists based on their corresponding list scores and selects one or more lists of items having at least a threshold position in the ranking. Alternatively, the item identification model 520 generates multiple lists 540 of items, where different lists 540 include at least one different item for at least one item category of the set 530 of item categories.

With the list 540 of items generated based on the query 505, the order generation agent 510 generates a prompt including the list 540 of items and an identifier of a corresponding retailer for input to the candidate order form creation model 525. In various embodiments, the prompt also includes metadata 535 extracted from the query 505 or obtained from the data store 240. The order generation agent 510 leverages metadata 535 describing prior orders received from the user 500 to generate an order form 545 including characteristics of an order to obtain items included in the list 540 of items from the corresponding retailer. Example characteristics of an order included in the order form 545 include a time interval for fulfilling the order, a payment method used by the user to pay for the order, a location where items of the list 540 of items are to be delivered, identifiers of items included in the order, or other information describing how a picker obtains the items and delivers the items to the user 500.

In various embodiments, the candidate order form creation model 520 is a generative model, such as large language model. As further described above in conjunction with FIG. 3, the online concierge system 140 tunes the candidate order form creation model 520 based on prior orders fulfilled for the user 500 and stored in the data store 240. Tuning the candidate order form creation model 520 using prior orders fulfilled for the user 500 allows the candidate order form creation model 520 to account for historical patterns or preferences of the user 500 when creating orders. This allows the candidate order form creation model 520 to tailor characteristics of an order to the user 500. Additionally, metadata 535 included in the prompt with the list 540 of items and the identifier of the retailer affects one or more characteristics of the order included in the order form 545.

The order from 545 includes characteristics of the order generated by the candidate order form creation model 520. For example, the order form 545 identifies the items of the list 540, a retailer from which the items are to be obtained, a location where the items are to be delivered, a time interval during which the items are to be delivered to the user 500, and a payment method for the online concierge system 140 to charge the user for the items. However, in other embodiments, the order form 545 includes different or additional characteristics for the order. In some embodiments, the online concierge system 140 generates an order 550 for obtaining the items of the list 540 from the corresponding retailer using the characteristics of the order included in the order form 545 without receiving an interaction from the user 500.

In other embodiments, as further described above in conjunction with FIG. 4, the online concierge system 140 transmits the order form 545 to the user client device 100 of the user 500 for review. In response to receiving approval of the order form 545 from the user 500 via the user client device 100, the online concierge system 140 generates the order 550 for the user 500 to obtain the items of the list 540 and having the characteristics specified by the order form 545. As further described above in conjunction with FIG. 4, the online concierge system 140 may receive a rejection of the order form 545 from the user 500 that includes one or more modifications to the order form 545. The candidate order form generation model 520 receives a prompt including the one or more modifications (e.g., a prompt from the ingredient identification model 515) based on the rejection. Based on the one or more modifications included in the prompt, the candidate order form generation model generates a modified order form 545 that is transmitted to the user client device 100 for review. In response to receiving an approval of the modified order form 545 via the user client device 100, the online concierge system 140 generates the order 550 using the characteristics included in the modified order from 545. This allows the user to iteratively modify one or more characteristics of the order through rejections provided to the order generation agent 510.

Hence, the order generation agent 510 generates a list 540 of items, identifies a retailer from which the list of items are obtained, and generates characteristics for the order 550 based on the query 505. This reduces an amount of interaction by the user 500 with the online concierge system 140 to generate the order 550. Rather than manually search items offered by a retailer and select individual items for inclusion in an order, the order generation agent 510 receives the query 505 and generates the list of items 540 and the characteristics of the order 550 based on the result for a combination of items included in the query 505. Such generation of a list 540 of items based on the query 505 by the order generation agent 510 reduces an amount of interaction with the online concierge system 140 by the user 500 to identify items for the order, increasing a likelihood of subsequent interaction with the online concierge system 140 by the user 500. Further, having the order generation agent 510 generate characteristics of the order 550 based on the list 540 of items and prior order from the user 500 further reduces an amount of interaction with the online concierge system 140 by the user 500 by allowing automatic configuration of characteristics of the order 550 to obtain the list 540 of items generated by the order generation agent 510.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
receiving a query from a user at the computer system, the query indicating a user intent;
generating a set of item categories based on the query by the computer system applying an ingredient identification model to the query, the ingredient identification model comprising a generative model tuned based on recipes obtained by the computer system, each recipe including a combination of item categories;
generating a list of items based on the set of item categories and a retailer associated with the list of items, the list of items including at least one item corresponding to each item category of the set of item categories;
generating an order form including characteristics of an order for the query, the order form based on the list of items and the retailer by applying a candidate order form creation model to the list of items and to the retailer, the candidate order form creation model comprising a generative model tuned based on prior orders previously fulfilled for the user;
transmitting the order form from the computer system to a client device of the user for display; and
generating an order having the characteristics included in the order form.

2. The method of claim 1, wherein generating the order having the characteristics included in the order form comprises:
receiving, at the computer system, an approval of the order form from the client device of the user; and
generating the order having the characteristics included in the order form in response to the computer system receiving the approval.

3. The method of claim 1, wherein generating the list of items based on the set of item categories and the retailer associated with the list of items comprises:
generating multiple candidate lists, each candidate list associated with a retailer within a threshold distance of a location associated with the user;
generating a list score for each candidate list, a list score for a candidate list based on one or more item attributes of items included in the candidate list; and
selecting one or more candidate lists based on the list scores.

4. The method of claim 3, wherein generating multiple candidate lists comprises including, in one or more of the multiple candidate lists, an item having an item attribute that comprises a predicted availability of the item at the retailer associated with the candidate list.

5. The method of claim 3, wherein generating multiple candidate lists comprises including, in one or more of the multiple candidate lists, an item having an item attribute that comprises a cost to the computer system of obtaining the item from the retailer associated with the candidate list.

6. The method of claim 3, wherein selecting one or more candidate lists based on the list scores comprises:
ranking the candidate lists based on the list scores; and
selecting one or more candidate lists having at least a threshold position in the ranking.

7. The method of claim 1, wherein receiving a query from a user at the computer system comprises receiving an image of the user intent as at least part of the query.

8. The method of claim 1, wherein receiving a query from a user at the computer system comprises receiving unstructured text including a description of the user intent as at least part of the query.

9. The method of claim 1, wherein generating the list of items based on the set of item categories and a retailer associated with the list of items comprises:
generating the list of items based on the set of item categories, retailers within a threshold distance of a location associated with the user and metadata associated with the user.

10. The method of claim 9, further comprising:
extracting, by the ingredient identification model, the metadata associated with the user from the query.

11. The method of claim 1, wherein generating the order form including characteristics of the order for the query comprises:
applying the candidate order form creation model to the list of items, the retailer, and metadata extracted from the query by the ingredient identification model.

12. A computer program product comprising a non-transitory computer readable storage medium having instructions encoded thereon that, when executed by a processor, cause the processor to perform steps comprising:
receiving a query from a user at an online concierge system, the query indicating a user intent;
generating a set of item categories based on the query by the online concierge system applying an ingredient identification model to the query, the ingredient identification model comprising a generative model tuned based on recipes obtained by the processor, each recipe including a combination of item categories;
generating a list of items based on the set of item categories and a retailer associated with the list of items, the list of items including at least one item corresponding to each item category of the set of item categories;
generating an order form including characteristics of an order for the query, the order form based on the list of items and the retailer by applying a candidate order form creation model to the list of items and to the retailer, the candidate order form creation model comprising a generative model tuned based on prior orders previously fulfilled for the user;
transmitting the order form from the online concierge system to a client device of the user for display; and
generating an order having the characteristics included in the order form.

13. The computer program product of claim 12, wherein generating the order having the characteristics included in the order form comprises:
receiving, at the online concierge system, an approval of the order form from the client device of the user; and
generating the order having the characteristics included in the order form in response to the online concierge system receiving the approval.

14. The computer program product of claim 12, wherein generating the list of items based on the set of item categories and the retailer associated with the list of items comprises:
generating multiple candidate lists, each candidate list associated with a retailer within a threshold distance of a location associated with the user;
generating a list score for each candidate list, a list score for a candidate list based on one or more item attributes of items included in the candidate list; and
selecting one or more candidate lists based on the list scores.

15. The computer program product of claim 14, wherein generating multiple candidate lists comprises including, in one or more of the multiple candidate lists, an item having an item attribute that comprises a predicted availability of the item at the retailer associated with the candidate list.

16. The computer program product of claim 14, wherein selecting one or more candidate lists based on the list scores comprises:
ranking the candidate lists based on the list scores; and
selecting one or more candidate lists having at least a threshold position in the ranking.

17. The computer program product of claim 12, wherein receiving a query from a user at the processor comprises receiving an image of the user intent as at least part of the query.

18. The computer program product of claim 12, wherein generating the list of items based on the set of item categories and a retailer associated with the list of items comprises:
generating the list of items based on the set of item categories, retailers within a threshold distance of a location associated with the user and metadata associated with the user.

19. The computer program product of claim 18, further comprising:
extracting, by the ingredient identification model, the metadata associated with the user from the query.

20. A system comprising:
a processor; and
a non-transitory computer readable storage medium having instructions encoded thereon that, when executed by the processor, cause the processor to perform steps comprising:
receiving a query from a user at an online concierge system, the query indicating a user intent;
generating a set of item categories based on the query by the online concierge system applying an ingredient identification model to the query, the ingredient identification model comprising a generative model tuned based on recipes obtained by the system, each recipe including a combination of item categories;
generating a list of items based on the set of item categories and a retailer associated with the list of items, the list of items including at least one item corresponding to each item category of the set of item categories;
generating an order form including characteristics of an order for the query, the order form based on the list of items and the retailer by applying a candidate order form creation model to the list of items and to the retailer, the candidate order form creation model comprising a generative model tuned based on prior orders previously fulfilled for the user;
transmitting the order form from the online concierge system to a client device of the user for display; and
generating an order having the characteristics included in the order form.
